(19) United States
(12) Patent Application Publication
(10) Pub. No.: US 2005/0252101 A1
(43) Pub. Date: Nov. 17, 2005

(54) Landscape edging blocks, systems, and methods

(75) Inventors: Mark Carlton Anderson, Buffalo Lake, MN (US); Dwight David Anderson, Champlin, MN (US); Paul Newton Anderson, Buffalo Lake, MN (US)

Correspondence Address: Kevin J. Hubbard;Kagan Binder, PLLC, Maple Island Building, 221 Main Street North, Suite 200, Stillwater, MN, 55082, US

(73) Assignee: HECTOR TILE COMPANY, INC.

(21) Appl. No.: 10/843,945

(22) Filed: May 12, 2004

(51) Int. Cl. A01G 1/00

(52) U.S. Cl. 52/102

(57) ABSTRACT

The present invention provides landscape edging blocks, block systems, and methods of manufacturing such blocks and block systems. Landscape edging blocks of the invention can be used to separate landscape regions from each other. For example, landscape edging blocks of the invention can be used to separate a lawn from a decorative bed or garden such as those containing flowers, shrubs, trees, and the like. Landscape edging blocks of the invention preferably include a display surface wherein aggregate material of the landscape edging block is exposed on at least a portion of the display surface to a greater degree than on at least one other surface of the landscape edging block. Also, landscape edging blocks of the invention preferably include an overlapping engagement system for positioning adjacent block with respect to each other. The overlapping system inhibits growth of grass or other vegetation between two adjoining blocks. Landscape edging blocks of the invention may be straight or curved, thus allowing multiple blocks to be assembled to form various configurations.

### TECHNICAL FIELD

The present invention relates generally to the field of landscaping. More particularly, the present invention relates to blocks that can be used to construct a border, curb, or edge, for decorative purposes or for separating landscape regions as well as methods of manufacturing such blocks.

### BACKGROUND

Numerous methods and materials exist for the construction of borders or edging for landscaping or site improvement work. Such borders or edges serve several functions. First, they can be decorative and provide an orderly transition from one landscape region to another such as from a garden area to a lawn, or from a lawn to a sidewalk, for example. Second, they can serve to separate different areas with different forms of vegetation or other landscaping elements. Third, such borders or edges can serve to reduce maintenance requirements such as removing weeds, or trimming back vegetation that would otherwise spread. If installed sufficiently low to the ground, they can also ease the process of lawn mowing by reducing or eliminating the need to hand trim the border areas of the lawn after mowing the main areas with a conventional lawn mower.

One method for the construction of edgings, for use around gardens and lawn regions or to divide sections of a garden or lawn, involves the use of extended lengths of flexible metal or plastic edging materials. These materials are then anchored by digging a trench, placing the edging material within the trench, anchoring the edging material by driving spikes through it into the ground, and then back-filling the trench with dirt. Such methods are common and relatively inexpensive, but have several disadvantages. First, these edgings do not have a natural, orderly appearance that is aesthetically pleasing in a landscaping application, having instead a man-made appearance. Also, these materials are not easily fixed in straight lines or measured curves due to their flexible nature. Many times, the plastic is difficult to straighten after having been packaged coiled or wound. Further, these materials are readily susceptible to damage or displacement during lawn mowing, digging, and other activities, such as where sharp objects may contact the material, especially a plastic material. Additionally, such edgings are susceptible to heaving from frost action in climates where the ground freezes.

Other methods of providing an edging include using natural stones or man-made bricks or blocks. Such stones or bricks are usually installed by digging a shallow trench and placing the stones or bricks more or less continuously along the length of the trench. Such materials may also simply be placed on top of the ground without digging a trench. Natural stone has long been used for this application; however, natural stone typically has irregular shapes and requires labor-intensive fitting of the natural stones along the border or edging or costly cutting of the stones to fit with one another. The irregularity of surface features also makes natural stone difficult to accommodate lawn mowing. Bricks or other rectangular blocks of clays, cements, or the like may also be used for lawn edging using similar installation techniques. However, rectangular blocks do not lend themselves to the construction of non-linear or curved edgings, which are found in many landscaping applications. For curved or angled patterns, the rectangular bricks or blocks need to be cut in order to avoid gaps that are undesirable as they may allow penetration of grass roots or other vegetation and to provide an orderly appearance.

Another method for forming an edging or border has been to pour a concrete edging in place. The disadvantages of this method are the expense and effort involved. To install such an edging, an adequate trench must be dug, then forms must be constructed laying out the line of the edging, then the concrete must be mixed, poured, and allowed to cure. Such edgings may also require the placement of expansion material filled joints, and are susceptible to cracking. In addition, such edgings are not readily removed in the event a change in the contour of the lawn or garden border is desired. Finally, such edgings do not provide a desirable natural appearance.

There have also been efforts to address some of these deficiencies in the prior art through masonry block designs and wet cast concrete designs that are meant specifically for use as an edging. These designs use either single units that are capable of being laid in straight or curved lines, or multiple unit systems with curved and straight pieces. These products are produced on concrete masonry block or paving machines, or through pre-casting with numerous concrete forms, and are designed to allow the construction of curved edgings. Such curbing suffers from many of the limitations discussed above regarding edging, e.g., lack of curvilinear construction without time-consuming and costly on-site cutting, and susceptibility to heaving from freeze/thaw cycles.

Paver stones, though usually used for areas such as patios and walkways, have also been used as landscape edging. Typically, pavers are restrained by plastic or metal strips fixed in a manner similar to the flexible edging materials discussed above. For similar reasons, pavers and their edge restraints are also difficult to fix in straight measured curves, and are susceptible to heave from freeze/thaw cycles.

### SUMMARY

The present invention provides landscape edging blocks, block systems, and methods of manufacturing such blocks and block systems. Landscape edging blocks in accordance with the present invention can be used to enclose a landscape region, separate landscape regions from each other, provide a distinctive appearance to a landscape region, provide a landscape border that prevents growth of vegetation between adjacent blocks, and provide a landscape border that is easy to mow around. For example, landscape edging blocks of the present invention can be used to enclose a tree or to separate a lawn from a decorative bed or garden such as those containing flowers, shrubs, trees, and the like.

Landscape edging blocks in accordance with the present invention provide many advantages. For example, such blocks provide an edging that can be easily and economically manufactured. In one preferred embodiment, landscape edging blocks are provided that can be used to form curved as well as straight landscape edges or borders with the same blocks. Advantageously, such landscape edging blocks can be made with the same mold. Moreover, economies of scale can be realized in manufacturing such blocks because plural individual landscape edging blocks can be made from one body that can be created by any block forming process, such as molding. That is, a body can be formed and subsequently divided to provide plural landscape edging blocks. However, blocks in accordance with the present invention can be formed individually and do not need to be formed by dividing a body to form plural blocks. Advantageously, a surface that is created when a cement-based body is divided into individual blocks has a surface with an aesthetically pleasing appearance and can be used as a display surface for the individual landscape edging block. Preferably, the display surface is provided as a block top surface to create a decorative effect facing upward as opposed to front decorative faces common with retaining blocks. Thus, when dividing a body into plural blocks, it is preferable to divide the body to create top surfaces of each block.

Landscape edging blocks in accordance with the present invention can also provide segmented landscape edging that has overlapping joints. Overlapping joints advantageously inhibit growth of grass and other vegetation between the blocks and thus provide a neat and groomed appearance to the landscape area. An overlapping joint also allows for small adjustments in alignment of adjacent blocks without creating gaps between blocks.

Another advantage of the landscape edging blocks in accordance with the present invention is that such blocks provide a landscape edging that is easy to initially install and easy to later modify, if desired. The edging of the present invention is easier to work with than concrete landscape edging that is poured or cast in place with a machine, which is a labor intensive process. Individual blocks for edging allow for modifications in alignment and positioning of the edging, as compared to poured edging. As such, any desired curve or path can be easily formed at any time. Moreover, individual blocks can be easily disassembled and relocated if a landscape edge or border needs to be moved or redefined.

Landscape edging bocks of this invention advantageously provide a landscape edging that is durable and attractive. The cement-based edging of the present invention is able to withstand lawn mowing equipment, which often damages flexible plastic edging. Additionally, the edging of the present invention is less likely to be damaged or displaced by soil movement due to frost heave. Cast in place concrete edging can often crack due to frost heave.

A further advantage of the landscape edging blocks in accordance with the present invention is that such blocks provide-an edging that facilitates landscape maintenance. The edging blocks of the present invention are preferably capable of being sufficiently buried so that the mower deck of a lawn mower can ride over the edging and thus reduce or eliminate the need for trimming. Moreover, landscape edging blocks in accordance with the present invention may include a key at an abutting region of such blocks that can help to prevent blocks from shifting with respect to each other.

Accordingly, in one aspect of the present invention, a landscape edging block is provided. Preferably, this landscape edging block comprises a body having first and second sides, first and second ends, a ground engaging surface extending between the first and second ends, and a display surface spaced from the ground engaging surface. Preferably, the body comprises a cement-based material containing an aggregate material. The display surface preferably comprises at least a surface portion wherein the aggregate material is exposed to a greater degree than on at least one other surface of the body.

In another aspect of the present invention a landscape edging block is provided. Preferably, this landscape edging block comprises a body having first and second ends, a ground engaging surface extending between the first and second ends, a display surface spaced apart from the ground engaging surface, a first engagement portion extending from the first end, and a second engagement portion similar to the first engagement portion extending from the second end.

In another aspect of the present invention, a method of making a landscape edging block is provided. Preferably, this method comprises a step of forming a landscape edging block from a cement-based material containing an aggregate material. The landscape edging block preferably has first and second sides, first and second ends, a ground engaging surface extending between the first and second ends, and a display surface spaced from the ground engaging surface. This method also preferably includes a step of at least partially exposing the aggregate material on at least a portion of the display surface to a greater degree than on at least one other surface of the landscape edging block.

In yet another aspect of the present invention, a method of making a plurality of landscape edging blocks is provided. Preferably, this method includes a step of providing a body comprising a cement-based material containing an aggregate material. This method also preferably includes a step of dividing the body along a predetermined separation plane to define a plurality of landscape edging blocks. Each of the plurality of landscape edging blocks preferably has first and second sides, first and second ends, a ground engaging surface extending between the first and second ends, and a display surface at least partially defined by the predetermined separation plane spaced from the ground engaging surface. This method also preferably includes a step of at least partially exposing the aggregate material on at least a portion of a display surface to a greater degree than on at least one other surface of a landscape edging block.

In yet another aspect of the present invention a method of making a landscape edge for separating a first landscape region of a ground surface from at least one other landscape region of the ground surface is provided. This method preferably comprises a step of providing a plurality of landscape edging blocks. Each landscape edging block preferably comprises a body having first and second sides, first and second ends, a ground engaging surface extending between the first and second ends, and a display surface spaced from the ground engaging surface. The body preferably comprises a cement-based material containing an aggregate material wherein the aggregate material is exposed on at least a portion of the display surface to a greater degree than on at least one other surface of the body. This method also preferably includes a step of arranging the plurality of landscape edging blocks end to end with the ground engaging surface of each landscape edging block in contact with the ground surface to form a landscape edge or border.

### BRIEF DESCRIPTION OF THE DRAWINGS

The accompanying drawings, which are incorporated in and constitute a part of this application, illustrate several aspects of the invention and together with a description of the embodiments serve to explain the principles of the invention. A brief description of the drawings is as follows:

FIG. 1 is a perspective view of a trapezoidal shaped landscape edging block in accordance with the present invention;

FIG. 2 is a top view of the landscape edging block of FIG. 1 showing a display surface of the landscape edging block in accordance with the present invention;

FIG. 3 is an end view of the landscape edging block of FIGS. 1 and 2;

FIG. 4 is a top view of a plurality of landscape edging blocks similar to the landscape edging block of FIGS. 1-3 arranged end to end to form a generally linear structure that can be used for a landscape border in accordance with the present invention;

FIG. 5 is a top view of an alternate arrangement for the landscape edging blocks of FIG. 4 which have been rearranged to form a curved structure that can be used for a landscape border in accordance with the present invention;

FIG. 6 is a top view of a portion of a landscape border set into the ground and made with landscape edging blocks similar to the landscape edging blocks of FIGS. 1-3;

FIG. 7 is a cross-sectional view of the landscape border of FIG. 6 taken along the line 7-7;

FIG. 8 is a perspective view of a body that can be divided to form plural landscape edging blocks in accordance with the present invention;

FIG. 9 is a perspective view of a pair of landscape edging blocks that can be formed by dividing the body of FIG. 8 in accordance with an aspect of the present invention;

FIG. 10 is a side view of a plurality of edging blocks having an engagement system that can be used with landscape edging blocks of the present invention;

FIG. 11 is a side view of a plurality of edging blocks having an overlapping engagement system in accordance with another aspect of the present invention that can be used with landscape edging blocks of the present invention;

FIG. 12 is a perspective view of another body in accordance with the present invention that can be divided to form plural landscape edging blocks having an overlapping engagement system;

FIG. 13 is a perspective view of a pair of landscape edging blocks that can be formed by dividing the body of FIG. 12 in accordance with the present invention;

FIG. 14 is a side view of the body of FIG. 12;

FIG. 15 is a side view of another body in accordance with the present invention that can be divided to form plural landscape edging blocks having an overlapping engagement system; and

FIG. 16 is a side view of yet another body in accordance with the present invention that can be divided to form plural landscape edging blocks having an overlapping engagement system.

### DETAILED DESCRIPTION

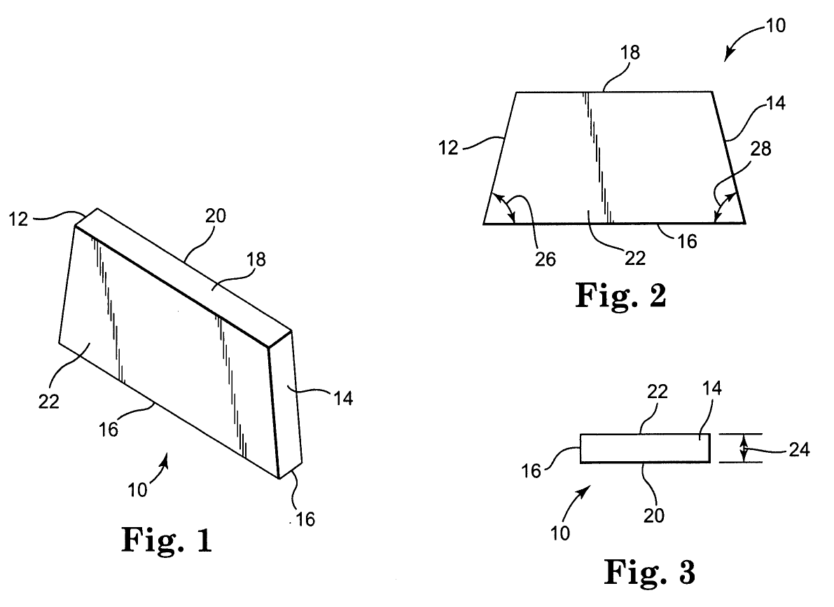

Referring to FIGS. 1-3, a first embodiment of a landscape edging block 10 in accordance with the present invention is shown. A perspective view of the landscape edging block 10 is shown in FIG. 1, and a top view and end view are shown in FIGS. 2 and 3, respectively. The landscape edging block 10 includes ends 12 and 14, sides 16 and 18, a ground engaging surface 20, and a display surface 22 that is spaced apart from the ground engaging surface 20 thereby defining a thickness 24 of the landscape edging block 10. Preferably, the thickness is selected so that the landscape edging block 10 can be sufficiently recessed or buried into the ground to provide a border that can be mowed over as described in more detail below.

In a preferred embodiment, and as described in more detail below, the display surface 22 comprises a surface or surface portion that can be formed by dividing a larger block to form plural portions, at least one portion of which comprises an edging block such as edging block 10. For example, a block of a cement-based material can be controllably fractured along a plane to form plural landscape edging blocks, such as the block 10. The fracture plane preferably defines a display surface that in this case would be a roughened or split face for an individual block. This can be done by breaking or fracturing a cured block (hard split) or by creating a roughened surface without breaking the block. For example, in one embodiment, a roughened surface can be formed by a soft split technique. Typically a soft split surface is made without fracturing the blocks but rather by using a roughened insert in a mold that is used to form the blocks. For example, one method for forming a roughened surface by a soft split technique is described in U.S. Pat. Nos. 5,078,940 and 5,217,630, which are fully incorporated herein by reference for all purposes. Other conventionally known techniques such as those capable of at least partially exposing aggregate within a cement-based material can be used. In any case, the display surface 22 preferably provides a viewable surface or portion thereof that is not buried or otherwise covered and can have any desired appearance as described below.

As can be seen best in FIG. 2, the landscape edging block 10 preferably has a trapezoidal shape when looking down at the display surface 22 when the landscape edging block 10 is installed as a portion of a landscape edge or border although other shapes are contemplated. For example, landscape edging blocks of the present invention can be square, rectangular, bullet shaped (one end convex and one end concave) or the like. Preferably, the sides 16 and 18 linearly extend between the ends 12 and 14 and are parallel to each other, as shown. However, the sides 16 and 18 do not need to be parallel and may curve or otherwise change direction in any manner in order to provide a desired appearance or structure. That is, landscape edging blocks of the present invention may be straight or may have a curvature along the sides 16 and 18 and/or ends 12 and 14 or portions thereof. Having blocks of various shapes and sizes provides versatility and allows a landscaper to customize the shape of the assembled edging to define or encompass a desired area. For example, a combination of blocks having different curve radiuses, and/or curving in opposite directions, allows one to make circular, scalloped or otherwise undulating borders. Preferably, such curved landscape edging blocks include a display surface formed in accordance with the invention.

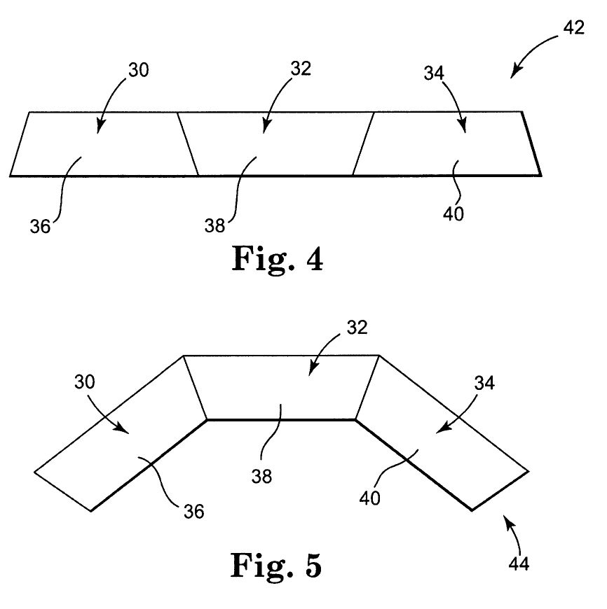

In the illustrated embodiment of FIGS. 1-3, the end 12 forms an acute angle 26 with the side 16 and the end 14 forms an acute angle 28 with the side 16. Preferably, the angles 26 and 28 are the same in order to provide the illustrated trapezoidal shape, but the angles 26 and 28 need not be the same. A trapezoidal shape advantageously allows for plural landscape edging blocks having a display surface to be arranged to provide an unlimited variety of desired paths for a landscape edge or border while maintaining the display surface in an upwardly facing and viewable direction. That is, a plurality of similar landscape edging blocks, such as the landscape edging block 10, can be used to provide linearly extending landscape edges as well as curved landscape edges without needing to turn the landscape edging blocks upside down thereby putting the display surface on the ground so that it cannot be seen or requiring both spaced surfaces 20 and 22 to be provided with a display feature. The landscape edging blocks in accordance with the present invention only need to be rotated in order to change the direction of a landscape border and the display surface can remain upwardly facing and viewable. For example, with reference to FIG. 4, a plurality of landscape edging blocks 30, 32, and 34 having display surfaces 36, 38, and 40, respectively, are shown arranged to form a linear landscape border 42. In FIG. 5, the same landscape edging blocks 36, 38, and 40 are shown arranged to form a curved landscape border 44. The linear landscape border 42 can be rearranged to form the curved landscape border 44 by rotating the landscape edging block 30 and the landscape edging block 34 by 180 degrees with respect to the landscape edging block 38. As such, the display surfaces 36, 38, and 40 can remain upwardly facing.

It is noted, however, that landscape edging blocks having shapes other than the trapezoidal shape of the landscape edging block 10 described above and shown in the Figures are contemplated including curved shapes. Preferably, such landscape edging blocks include a display surface in accordance with the present invention, such as a split face or fracture surface as describe in more detail below. In particular, the angles 26 and 28 do not need to be the same. For example, one of the angles 26 and 28 could be a right angle to provide a landscape edging block having a square end. If desired, both angles 26 and 28 could be right angles to form a square or rectangular landscape edging block or both ends could be angled in the same direction such as to provide a parallelogram shape. Moreover, the angle 26 can be any desired angle and the angle 28 can be any desired angle for providing a landscape edging block for a particular application.

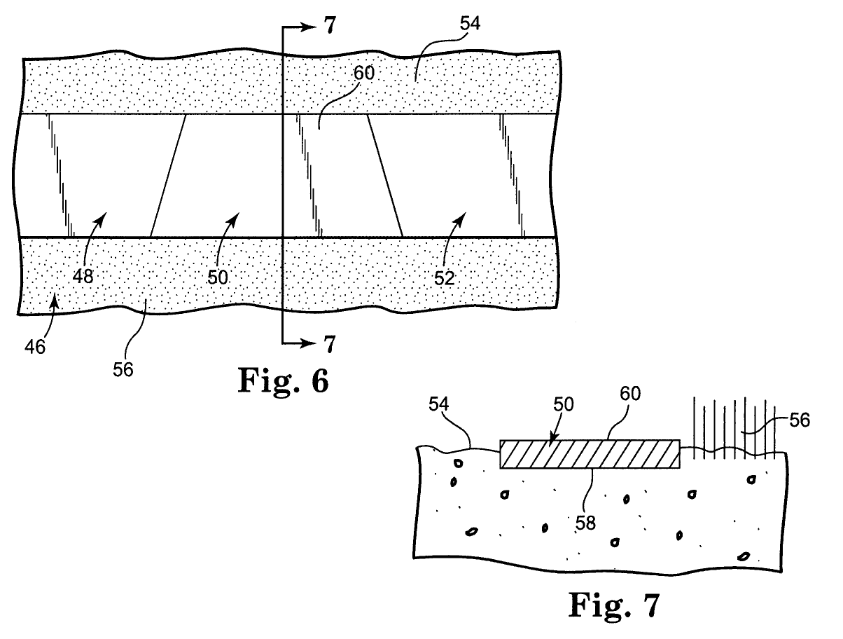

With reference to FIG. 6, a typical application for landscape edging blocks of the present invention, is illustrated. Landscape edge or border 46 is shown as including landscape edging blocks 48, 50, and 52 that are arranged to form a continuous border portion. Landscape edging blocks 48, 50, and 52 can be similar to landscape edging block 10, for example. As shown, the landscape border 46 provides a separation or break between landscape area 54 and landscape area 56. For the purposes of illustration, the landscape area 56 comprises grass, such as in a yard, and the landscape area 54 comprises a flowerbed. It is noted, however, that the landscape border 46 can be used to separate or define any desired landscape areas. Often, a landscape border 46 encircles or encompasses an area such as a tree or flowerbed. Also, the landscape border 46 can be a boundary or border for keeping loose items such as decorative woodchips or rocks separated from another area such as a grass filled yard. The landscape border 46 can also be used as a border or edge for a path, walkway, driveway, patio, sandbox, pool, or the like. It is also contemplated that the landscape border 46 can also be used as a fence underlayment. As such, the landscape border 46 can be integrated with fence structures such as posts or cross-members.

In FIG. 7, the landscape border 46 is illustrated in cross-section. The landscape edging block 50 includes a ground engaging surface 58 and a display surface 60. As shown, the landscape edging block 50 is recessed into the ground. However, the landscape edging block 50 can be placed directly on the ground surface if desired. Preferably, when the landscape edging block 50 is to be used for separating grass from another landscape region, as illustrated, the landscape edging block 50 is recessed into the ground so that the display surface 60 is approximately even with or slightly raised to the ground. That is, the landscape edging block 50 is preferably sufficiently recessed into the ground so that a mower deck of a lawn mower can ride over the edging block 50 so that a blade of the mower deck will not interfere with or hit the edging block 50.

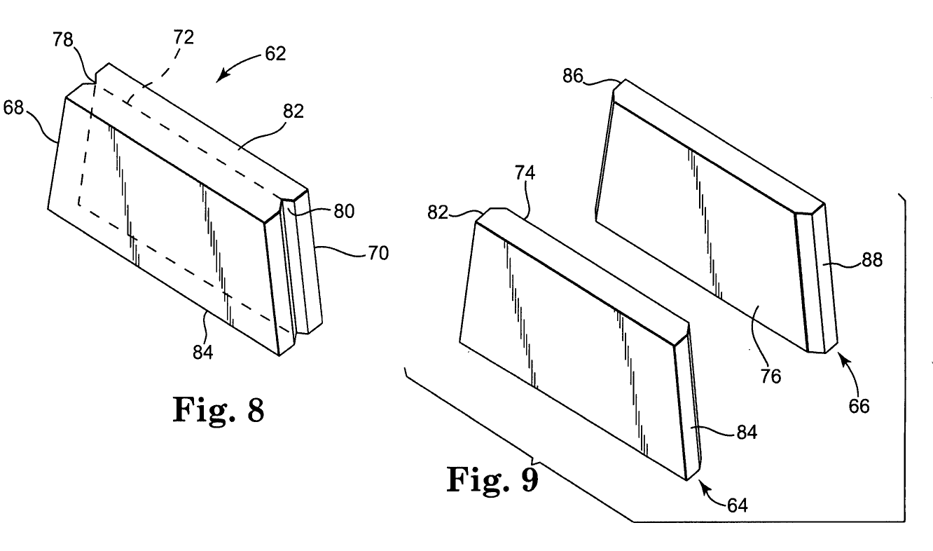

In accordance with one preferred aspect of the invention, a display surface of a landscape edging block preferably comprises a surface formed by fracturing, breaking, dividing, or splitting a cement-based body into plural portions such as by using hard split and/or soft split techniques. In FIG. 8, for example, a body 62 is shown. In accordance with one aspect of the present invention, the body 62 is designed so that it can be divided into landscape edging blocks 64 and 66, shown individually in FIG. 9. It is noted that the body 62 can be designed to be divided into any number of individual landscape edging blocks. As an example, the landscape edging blocks 64 and 66 can be similar to the landscape edging block 10 described above and the body 62 can be made from a cement-based material by a molding process, as described in more detail below.

A display surface in accordance with the present invention can also be formed by using a surface treatment after the surface is formed. That is, a surface can be formed by cutting, breaking, molding, polishing, burnishing, or other process and the surface can be subsequently treated to provide a desired appearance or finish. A display surface preferably has a roughened natural appearance but can also include smooth or flat portions, striations or grooves or other surface features. Such features may be provided after initial molding as in splitting or otherwise processing a surface, and/or as part of the body forming process as in molding with grooves or any pattern to the display surface.

Preferably, in accordance with the present invention, a landscaping edging block is formed from a cement-based material that contains an aggregate such a concrete material or the like. A display surface, in accordance with the present invention, preferably comprises exposed aggregate material to give the display surface a roughened texture and a natural appearance (as compared to the unnatural look of a smooth concrete surface where a substantial amount of the aggregate material is buried or covered with cement-based material). Exposed aggregate generally includes aggregate material that is not hidden or covered by the cement-based material. In accordance with one aspect of the present invention, aggregate material is exposed to a greater degree on a display surface than on other surfaces of a landscape edging block (such as surfaces that are formed by a molding process as described below).

Many factors can be used when selecting aggregate material to be added to a cement-based material for making a landscape edging block in order to control the appearance of a display surface in accordance with the present invention. For example, control and/or selection of the size, shape, particle size distribution, color, ratio of aggregate to cement, and/or material, etc. can be used to achieve a desired appearance for a display surface. Moreover, any material can be used as an aggregate material including stone, metal, paint chips, glass, and the like for providing a desired visual appearance to a display surface.

With reference to FIGS. 8 and 9, the body 62 is preferably designed to have a shape that corresponds with the desired shape of the particular landscape edging blocks to be made. As shown, the body 62 comprises a trapezoidal shape for forming the trapezoidal shaped landscape edging blocks 64 and 66. As such, the body 62 has a tapered shape defined by ends 68 and 70 that advantageously facilitates removal of the body 62 from a mold during a manufacturing process.

In accordance with an aspect of the present invention, the body 62 can be divided along a plane 72 to form the landscape edging blocks 64 and 66 and to create a display surface 74 for the landscape edging block 64 and a display surface 76 for the landscape edging block 66. However, it is noted that any surface can be used as a display surface, such as a molded, stamped, fractured, or otherwise formed surface. The body 62 can be divided by any desired technique capable of separating the body 62 into the landscape edging blocks 64 and 66. Preferably, a technique that fractures or breaks the body 62, such as by propagation of a crack along the plane 72 is used. For example, a chisel and hammer or any conventional or developed machine that performs a similar function can be used. Also, it is noted that a sawing or cutting process can be used, if desired. Moreover, a soft split technique can be used to form a display surface as part of a molding process.

Preferably, the body 62 includes grooves 78 and 80 that can function to guide propagation of a crack through the body 62. As shown, the groove 78 is formed in the end 68 and the groove 80 is formed in the end 70. Preferably, the grooves 78 and 80 extend between a side surface 82 and a side surface 84 of the body 62. A sharp blade such as a chisel blade can be positioned on a side surface 82 so that the blade extends substantially between the grooves 78 and 80 while positioned on the side surface 82. When the blade is forced against side surface 82 with a hydraulic cylinder, for example, the blade creates a crack that propagates along the plane 72. The grooves 78 and 80 help to guide the propagation of the crack along the plane 72. The grooves 78 and 80 can have any configuration but preferably define a line for at least partially defining a fracture plane such as the plane 72 as illustrated. Preferably, the grooves 78 and 80 are molded into the body 62 when the body 62 is molded. However, the grooves 78 and 80 can be formed after the body 62 is formed. For example, the grooves 78 and 80 can be formed by using a chisel or by using a device such as a grinding wheel or other cutting tool, or the like.

By dividing the body 62 by a technique involving fracturing or breaking, an aesthetically pleasing appearance can be obtained. This is because when a molding process is used to form the body 62, the surfaces of the mold are typically smooth to facilitate easy removal of the body 62 from the mold. Such smooth surfaces can have an unnatural look. Thus, by fracturing the body 62, a roughened surface can be obtained that has a more natural and esthetically pleasing appearance.

Landscape edging blocks of the present invention such as the landscape edging blocks 64 and 66 preferably comprise an engagement system for mating adjacent landscape edging blocks when such blocks are assembled to form a landscape edge or border. By use of the term “engagement system,” what is meant is a system that has portions that are capable of engaging, meshing, interlocking, interjoining, or otherwise coordinating together to provide abutting relation. Preferably, an overlapping engagement system is used as is described in more detail below. Some exemplary engagement systems that can be used with landscape edging blocks of the present invention are disclosed in Applicants' copending U.S. patent application to Anderson et al., entitled “Landscape Edging, and Methods,” filed on Aug. 13, 2003 and having application Ser. No. 10/639,822, which disclosure is fully incorporated by reference herein.

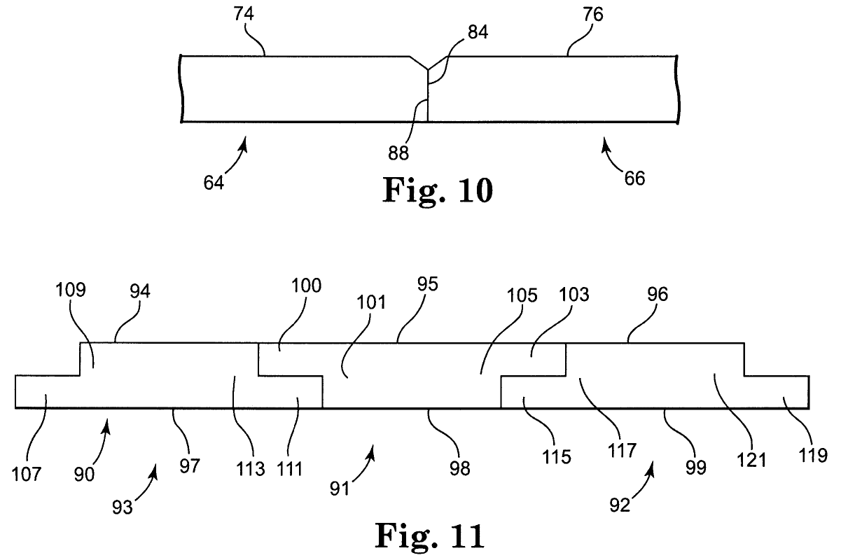

With reference to FIG. 9, landscape edging block 64 includes side surfaces 82 and 84 that are preferably generally normal to surface 74, as shown. However, side surfaces 82 and 84 can be provided at any angle to surface 74. Similarly, landscape edging block 66 includes side surfaces 86 and 88 that are preferably also generally normal to surface 76, as shown. Likewise, side surfaces 86 and 88 can be provided at any angle to surface 76. Landscape edging blocks 64 and 66 can be positioned next to each other so that the end 84 of the block 64 will abut the end 88 of the block 66 as illustrated in FIG. 10 thereby forming a butt joint. As such, the ends 84 and 88 together form an engagement system.

As mentioned above, an overlapping engagement system is preferably used with any of the edging blocks in accordance with the present invention. Referring to FIG. 11, an exemplary overlapping engagement system in accordance with another aspect of the present invention is shown that can be used with any of the landscape edging blocks of the present invention. Landscape edging blocks having any shape (trapezoidal, bullet-shaped, for example) can be used. As illustrated, landscape edging blocks 90, 91, and 92 are arranged to form a landscape border 93. Preferably, the landscape edging blocks 90, 91, and 92 comprise display surfaces 94, 95, and 96 and ground engaging surfaces 97, 98, and 99, respectively. Preferably, landscape edging block 91 includes an upper engagement portion 100 at a first end 101 and an upper engagement portion 103 at a second end 105. Preferably, the upper engagement portion 100 at the first end 101 is similar to the upper engagement portion 103 at the second end 105. As illustrated, the landscape edging block 90 includes a lower engagement portion 107 at a first end 109 and a similar lower engagement portion 111 at a second end 113. Likewise, as illustrated, the landscape edging block 92 includes a lower engagement portion 115 at a first end 117 and a similar lower engagement portion 119 at a second end 121. As such, the landscape edging block 91 is preferably different (with respect to the engagement portion) from the landscape edging blocks 90 and 92 and a pair of landscape edging blocks such as the block 90 and 91 form a system that can be used to provide a landscape border in accordance with the present invention.

Preferably, an upper engagement portion such as the upper engagement portion 100 and a lower engagement portion such as the lower engagement portion 111 are designed to be able to fit together so that at least a portion of the upper engagement portion and the lower engagement portion overlap with each other as illustrated. As shown, the upper engagement portion 100 preferably provides an extension of the display surface 95 of the block 91 and the lower engagement portion 111 preferably provides an extension of the ground engaging surface 97 of the block 90. As such, the upper engagement portion 100 is complimentary to the lower engagement portion 111 to provide an overlapping joint. It is noted, that such an overlapping joint can be provided in any manner by using any type of engagement portion or mating feature such that at least a portion of one landscape edging block overlaps at least a portion of another landscape edging block for providing a landscape edging border. Providing this type of overlapping joint can prevent vegetation from growing in between the landscape edging blocks. Moreover, by using an overlapping engagement system, adjustments in alignment of adjacent blocks can be made without creating gaps between the blocks based upon the degree of overlap. The illustrated upper and lower engagement portions 100, 103, 107, 111, 115 and 119 are defined by vertical and horizontal surfaces to create an overlap system in accordance with the present invention. Moreover, it is preferable that the upper and lower portions are complimentary to provide a good fit with one another. However, the features need not comprise any or all complimentary surfaces to provide an overlap system in accordance with the present invention. Such surfaces themselves can be other than flat and arranged in any way other than vertical and horizontal (angled, for example) in order to create an overlap.

Optionally, an engagement system can include features or structure for preventing lateral movement between adjacent blocks, which features can be incorporated within the block design or may include additional elements or hardware. Movement of this type can be caused by large mowers pushing against the blocks. Such structure can include locking features or elements such as a male and female locking system to prevent lateral movement of adjacent blocks. For example, a keyed structure such as a tongue and mortise can be used.

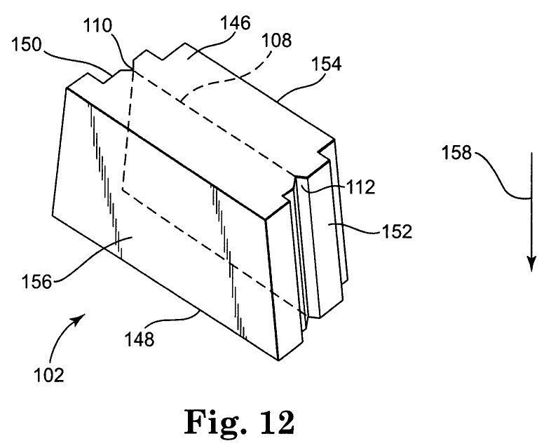

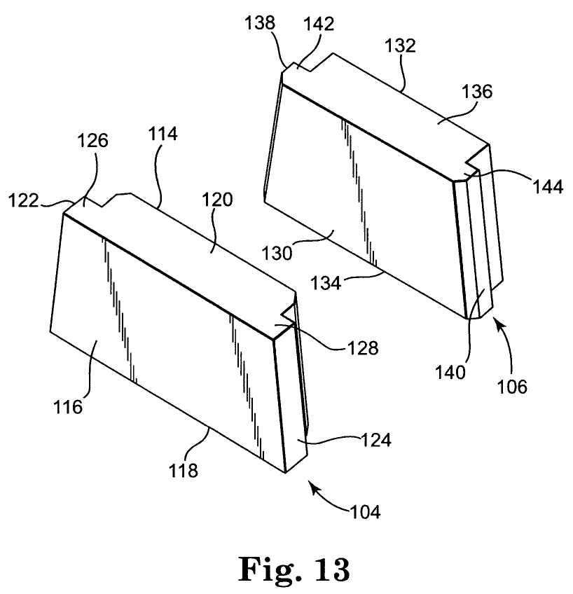

With reference to FIG. 12, a preferred embodiment of a body 102 is illustrated. The body, as shown, includes sides 146 and 148, ends 150 and 152, and a top 154 and bottom 156. The body 102 can be used to form landscape edging blocks 104 and 106 shown individually in FIG. 13 that use an example of an overlapping engagement system in accordance with the present invention. Preferably, the overlapping engagement system used by the blocks 104 and 106 is similar to the overlapping engagement system described above with respect to FIG. 11 although any other overlapping engagement system can be used. Preferably, the body 102 is designed so that it can be divided along plane 108 and may be similar to the body 62 described above. In particular, the body 102 preferably includes grooves 110 and 112, which can be similar to the grooves 78 and 80 described above with respect to the body 62. Also, the body 102 is preferably overall trapezoidal in shape, as described above with respect to the body 62, for forming trapezoidal shaped landscape edging blocks; however, the body 102 can be formed to have any desired shape as is noted above.

Referring to FIG. 13, the landscape edging block 104 preferably includes a display surface 114, a ground engaging surface 116, sides 118 and 120, and ends 122 and 124. Preferably, the end 122 includes a lower engagement portion 126 and the end 124 includes a similar lower engagement portion 128, as illustrated. The landscape edging block 106 preferably includes a display surface 130, a ground engaging surface 132, sides 134 and 136, and ends 138 and 140. Preferably, the end 138 includes upper engagement portion 142 and the end 140 includes a similar upper engagement portion 144, as illustrated. The display surfaces 114 and 130 are preferably formed by fracturing or breaking as described above although other techniques may be used. Preferably, the lower engagement portions 126 and 128 are designed to form an overlapping engagement system with the upper engagement portions 142 and 144. For example, an overlapping engagement system as shown and described above with respect to FIG. 11 can be incorporated into the design of body 102 and thus the block designs.

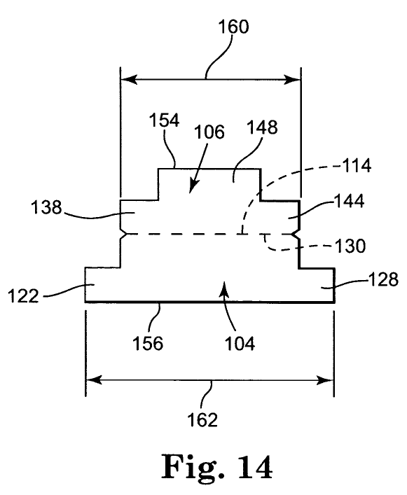

With reference to FIG. 14, the side 148 of the body 102 is shown prior to being separated into the landscape edging blocks 104 and 106. Preferably, and as shown, the width 160 of the landscape edging block 106 is less than the width 162 of the landscape edging block 104. The display surfaces 114 and 130 can therefore be formed to have the same dimensions, as illustrated. Moreover, this allows the engagement portions 122, 128, 138, and 144 to be defined while also providing equally sized display surfaces for each block.

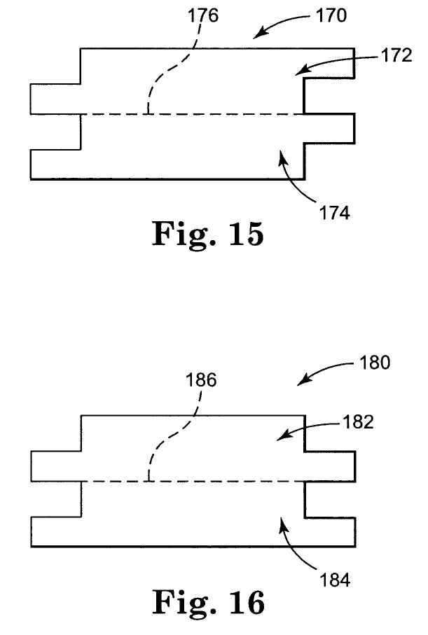

In FIG. 15, a side view of another body 170 is shown. The body 170 can be used to form landscape edging blocks 172 and 174 that preferably use an overlapping engagement system in accordance with the present invention. Preferably, the overlapping engagement system used by the blocks 172 and 174 is similar to the overlapping engagement system described above with respect to FIG. 11 although any other overlapping engagement system can be used. Preferably, the body 170 is designed so that it can be divided along plane 176 and may be similar to the body 62 described above. The body 170 may also include grooves or other feature for providing a guide for dividing the body 170 along the plane 176. For example, grooves, score lines, or other similar features that function in a manner similar to the grooves 78 and 80 described above with respect to the body 62 may be used to guide division of the body 170 along the plane 176. Moreover, a soft split technique can be used to divide the body 170 into the blocks 172 and 174. Also, the body 170 may have an overall trapezoidal shape, as described above with respect to the body 62, for forming trapezoidal shaped landscape edging blocks; however, the body 170 can be formed to have any desired shape as is noted above.

In FIG. 16, a side view of yet another body 180 is shown. The body 180 can be used to form landscape edging blocks 182 and 184 that preferably use an overlapping engagement system in accordance with the present invention. Preferably, the overlapping engagement system used by the blocks 182 and 184 is similar to the overlapping engagement system described above with respect to FIG. 11 although any other overlapping engagement system can be used. Preferably, the body 180 is designed so that it can be divided along plane 186 and may be similar to the body 62 described above. The body 180 may also include grooves or other feature for providing a guide for dividing the body 180 along the plane 186. For example, grooves, score lines, or other similar features that function in a manner similar to the grooves 78 and 80 described above with respect to the body 62 may be used to guide division of the body 180 along the plane 186. Moreover, a soft split technique can be used to divide the body 180 into the blocks 182 and 184. Also, the body 180 may have an overall trapezoidal shape, as described above with respect to the body 62, for forming trapezoidal shaped landscape edging blocks; however, the body 180 can be formed to have any desired shape as is noted above.

Landscaping edging blocks of the invention can be designed to have an aesthetic look selected to complement the landscaping and the property. For example, the landscape edging blocks can have a color rather than merely cement or concrete color. Common colors include gray, sand, tan, red, brown, and the like. The blocks may have a mottled look. The color can be present throughout the block, which is done by adding pigment to the concrete during manufacture of the block, or the color can be present on only the surface of the block. For example, a surface of a landscape edging block can be stained with a dye to provide a desired appearance.

The landscape blocks can additionally or alternatively have a decorative or ornamental surface pattern, such as a brick pattern, a field stone pattern, or the like. A natural, rough look, simulating the appearance of broken stone, could alternatively been used. Such patterns can be provided to the block during molding of the block, or can be subsequently applied.

Landscape edging blocks of the present invention, can be made by conventional block forming techniques used in the cement and concrete industry. Although the term “cement-based” is used herein, it is understood that any material can be used to form the landscape edging blocks. One method for making landscape edging blocks of the invention is by a “poured in place” method, where concrete is poured into a mold. A preferred technique is one commonly referred to as dry casting or known under the trade name of “Dri-Cast.” Using this method, the cast concrete block is removed from the mold prior to a curing step. When using a casting or dry casting method, typical concrete ingredients, water, cement, sand, and aggregate, are mixed. Pigment may be optionally added. A wide variety of mixtures are known to make blocks having various characteristics such as strength, water absorption, density, shrinkage, and other factors meeting ASTM standards and depending on the desired application of the block. When using dry casting techniques, the amount of water in the mixture is significantly less than that used for common concrete casting or wet casting. After mixing, the mixture is placed in a hopper that transports the mixture to a block molding machine. Any block molding machine known in the art may be used. Suitable molding machines for dry casting procedures are available, for example, from Besser Company of Alpena, Mich. The mixture or fill is then poured or loaded into a mold sitting on a large plate. The mold is configured to provide the desired block as a single unit. Often, multiple blocks are obtained from one mold. After filling, the top of the mold is scraped with a cut-off bar to remove excess concrete mixture. The mold and concrete is then subjected to vertical compression to consolidate the concrete within the mold for a period of time sufficient to form a solid, contiguous block. Generally, each block producing cycle has a duration of six to twelve seconds at a total load of 1500 to 2000 pounds. Additionally, the mold and/or the plate may be agitated during compression. Once the compression is complete, the plate is lowered vertically away from the mold into a de-molding or stripped position and the newly molded block is pushed downward through the mold so that it remains on the plate. Accordingly, the trapezoidal shaped blocks of the present invention can be easily removed from a mold because the trapezoidal shape provides tapered sides that easily release from a mold. It is noted that landscape edging blocks in accordance with the present invention may include any desired drafts or tapers on any portion of the block for facilitating release from a mold as part of a molding process.

Once the block is formed, it is cured by various means known in the art. Typically, blocks are cured in kilns for up to twenty-four hours under pressure and/or under high temperature, typically with steam. Once cured, multiple connected blocks may be separated by known methods. After being separated, individual blocks are palletized or otherwise packaged for shipment or storage.

Landscape edging blocks of the present invention can be installed by a professional landscaper or by a homeowner, using minimal equipment. Prior to installation, the design for the desired edging border should be planned. Using a combination of straight and arced blocks, either or both convex and concave blocks, provides a natural, flowing edging that adapts to the landscape and is aesthetically pleasing.

Once obtained, the blocks can merely be placed on the ground surface. In some embodiments, it may be desirable to remove any grass or other vegetation that would be present under the edging blocks. A trench or ditch may be dug to seat the blocks. It may be desirable to include a base of gravel, rock or sand under the blocks for stability and/or to provide for drainage. Once a first block is placed on the ground, the first end of the first block is placed against the second end of a second block. In such a continuing manner, the individual blocks are arranged to create the desired edging. It is not necessary that the first end of a first block tightly abut the second end of a second block. Especially where an overlapping engagement system is used, a slight spacing can be maintained between adjacent blocks without allowing grass or other vegetation to grow therebetween. Similarly, it is not necessary that the first end of the first block be square with the second end of the second block, rather, the blocks may be angled with respect to one another.

Because of the individual blocks forming the edging border, the layout of the landscape edging can be changed, as desired. For example, the shape of the edging border can be modified, or additional blocks can be added or removed to change the shape and enclosed size of the border.

The present invention has now been described with reference to certain specific embodiments. The foregoing detailed description has been given for clarity of understanding. Others may recognize that changes can be made in the described embodiments without departing from the scope and spirit of the invention. Thus, the scope of the present invention should not be limited to the exact details and structures described herein.

1. A landscape edging block that can be positioned with respect to at least one additional landscape edging block on a ground surface to define a portion of a landscape edge, the landscape edging block comprising a body having first and second sides, first and second ends, a ground engaging surface extending between the first and second ends, and a display surface spaced from the ground engaging surface, the body comprising a cement-based material containing an aggregate material wherein the aggregate material is exposed on at least a portion of the display surface to a greater degree than on at least one other surface of the body.

2. The landscape edging block of claim 1, wherein the display surface has a surface roughness that is greater than the surface roughness of at least one other surface of the body.

3. The landscape edging block of claim 1, wherein the body comprises a trapezoidal shape when viewing the body in a direction normal to the display surface.

4. The landscape edging block of claim 1, wherein the first end of the body comprises an extension portion that extends away from the body and comprises at least a portion of the display surface.

5. The landscape edging block of claim 4, wherein the second end of the body comprises an extension portion that extends away from the body and comprises at least a portion of the display surface.

6. The landscape edging block of claim 5, wherein the engagement portion of the first end comprises an engagement portion similar to the engagement portion of the second end.

7. The landscape edging block of claim 1, wherein the first end of the body comprises an extension portion that extends away from the body and comprises at least a portion of the ground engaging surface.

8. The landscape edging block of claim 7, wherein the second end of the body comprises an extension portion that extends away from the body and comprises at least a portion of the ground engaging surface.

9. The landscape edging block of claim 8, wherein the engagement portion of the first end comprises an engagement portion similar to the engagement portion of the second end.

10. A landscape edging block that can be positioned with respect to at least one additional landscape edging block on a ground surface to define a portion of a landscape edge, the landscape edging block comprising a body having first and second ends, a ground engaging surface extending between the first and second ends, a display surface spaced apart from the ground engaging surface, a first engagement portion extending from the first end, and a second engagement portion similar to the first engagement portion extending from the second end.

11. The landscape edging block of claim 10, wherein the body of the landscape edging block comprises a trapezoidal shape when viewing the body in a direction normal to the display surface.

12. The landscape edging block of claim 10, wherein the body comprises a cement-based material containing an aggregate material wherein the aggregate material is exposed on at least a portion of the display surface to a greater degree than on at least one other surface of the body.

13. The landscape edging block of claim 10, wherein the engagement portion of the first end of the body comprises an extension portion that extends away from the body and comprises at least a portion of the display surface.

14. The landscape edging block of claim 13, wherein the engagement portion of the second end of the body comprises an extension portion that extends away from the body and comprises at least a portion of the display surface.

15. The landscape edging block of claim 10, wherein the engagement portion of the first end of the body comprises an extension portion that extends away from the body and comprises at least a portion of the ground engaging surface.

16. The landscape edging block of claim 15, wherein the engagement portion of the second end of the body comprises an extension portion that extends away from the body and comprises at least a portion of the ground engaging surface.

17. The landscape edging block of claim 10, wherein the display surface comprises at least one groove formed therein.

18. The landscape edging block of claim 10, further in combination with a second landscape edging block comprising a body having first and second ends and an engagement feature extending from at least one of the first and second ends wherein the engagement feature of the second landscape edging block is different from the first and second engagement features of the first landscape edging block and capable of fitting together with at least one of the first and second engagement features of the first landscape edging block to form a landscape edge.

19. The landscape edging block of claim 18, wherein the body of the second landscape edging block comprises a ground engaging surface extending between the first and second ends and a display surface spaced apart from the ground engaging surface.

20. A method of making a landscape edging block, the method comprising the steps of:
forming a landscape edging block from a cement-based material containing an aggregate material, the landscape edging block having first and second sides, first and second ends, a ground engaging surface extending between the first and second ends, and a display surface spaced from the ground engaging surface; and
at least partially exposing the aggregate material on at least a portion of the display surface to a greater degree than on at least one other surface of the landscape edging block.

21. The method of claim 20, wherein the step of forming a landscape edging block comprising shaping the landscape edging block to have a trapezoidal shape when viewing the landscape edging block in a direction normal to the display surface.

22. The method of claim 21, wherein the step of forming a landscape edging block comprises forming an extension portion that extends away from the first end of the landscape edging block and comprises at least a portion of the display surface.

23. The method of claim 22, wherein the step of forming a landscape edging block comprises forming an extension portion that extends away from the second end of the landscape edging block and comprises at least a portion of the display surface.

24. The method of claim 21, wherein the step of forming a landscape edging block comprises forming an extension portion that extends away from the first end of the landscape edging block and comprises at least a portion of the ground engaging surface.

25. The method of claim 24, wherein the step of forming a landscape edging block comprises forming an extension portion that extends away from the second end of the landscape edging block and comprises at least a portion of the ground engaging surface.

26. The method of claim 21, wherein the step of at least partially exposing the aggregate material comprises providing a body having a volume larger than that of the landscape edging block and fracturing the body along a predetermine plane to define at least a portion of the display surface.

27. The method of claim 21, wherein the step of at least partially exposing the aggregate material comprises removing at least a portion of the cement-based material while the cement-based material is partially cured to define at least a portion of the display surface.

28. A method of making a plurality of landscape edging blocks, the method comprising the steps of:
providing a body comprising a cement-based material containing an aggregate material;
dividing the body along a predetermined separation plane to define a plurality of landscape edging blocks, each of the plurality of landscape edging blocks having first and second sides, first and second ends, a ground engaging surface extending between the first and second ends, and a display surface at least partially defined by the predetermined separation plane spaced from the ground engaging surface; and
at least partially exposing the aggregate material on at least a portion of the display surface to a greater degree than on at least one other surface of the landscape edging block.

29. The method of claim 28, wherein each of the defined landscape edging blocks comprises a trapezoidal shape when viewing the landscape edging block in a direction normal to the display surface.

30. The method of claim 28, wherein the step of providing a body comprises partially curing the cement-based material.

31. The method of claim 30, wherein the step of dividing the body comprises dividing the body along the predetermined separation plane while the cement-based material is partially cured.

32. The method of claim 28, wherein the step of providing a body comprises substantially curing the cement-based material.

33. The method of claim 32, wherein the step of dividing the body comprises dividing the body along the predetermined separation plane while the cement-based material is substantially cured.

34. A method of making a landscape edge for separating a first landscape region of a ground surface from at least one other landscape region of the ground surface, the method comprising the steps of:
providing a plurality of landscape edging blocks, each landscape edging block comprising a body having first and second sides, first and second ends, a ground engaging surface extending between the first and second ends, and a display surface spaced from the ground engaging surface, the body comprising a cement-based material containing an aggregate material wherein the aggregate material is exposed on at least a portion of the display surface to a greater degree than on at least one other surface of the body; and
arranging the plurality of landscape edging blocks end to end with the ground engaging surface of each landscape edging block in contact with the ground surface.

35. The method of claim 34, wherein the step of providing a plurality of landscape edging blocks comprises providing at least one landscape edging block that comprises a trapezoidal shape when viewing the landscape edging block in a direction normal to the display surface.

36. The method of claim 34, wherein the step of providing a plurality of landscape edging blocks comprises providing at least one pair of landscape edging blocks, the pair of landscape edging blocks comprising a first landscape edging block having a similar first engagement feature extending from the first and second ends of the first landscape edging block and comprising at least a portion of the display surface and a second landscape edging block having a similar second engagement feature extending from the first and second ends of the second landscape edging block and comprising at least a portion of the ground engaging surface of the second landscape edging block.

37. The method of claim 36, wherein the step of arranging the plurality of landscape edging blocks comprises overlapping the first engagement feature of the first end of the first landscape edging block of the pair of landscape edging blocks with the second engagement feature of the first end of the second landscape edging block of the pair of landscape edging blocks.
